(19) United States
(12) Patent Application Publication
(10) Pub. No.: US 2005/0108050 A1
(43) Pub. Date: May 19, 2005

(54) Medical information user interface and task management system

(76) Inventor: Claus Knapheide, Philadelphia, PA (US)

Correspondence Address: Alexander J. Burke;Intellectual Property Department, 5th Floor, 170 Wood Avenue South, Iselin, NJ, 08830, US

(21) Appl. No.: 10/963,915

(22) Filed: Oct. 13, 2004

Related U.S. Application Data
(60) Provisional application No. 60/514,788, filed on Oct. 27, 2003.
(60) Provisional application No. 60/511,036, filed on Oct. 14, 2003.

(51) Int. Cl. G06F 17/60

(52) U.S. Cl. 705/2

(57) ABSTRACT

A healthcare delivery information management system, for managing provision of health care to a patient, includes an interface processor and a display processor. The interface processor receives information identifying a particular patient. The display processor initiates generation of data representing a composite display image including a first area, a second area, and a third area. The first area includes a first set of data items representing different types of healthcare information, and a second set of data items individually associated with corresponding items of the first set of data items. The display processor initiates generation of data representing a particular type of healthcare information for the particular patient in the second area in response to user selection of an individual item of the first set of data items. The display processor initiates generation of data representing current healthcare information of a particular type for the particular patient in the third area in response to user selection of an individual item of the second set of data items.

### CROSS-REFERENCE TO RELATED APPLICATIONS

The present application is a non-provisional application of provisional application having Ser. No. 60/514,788 filed by Claus Knapheide on Oct. 27, 2003 and of provisional application having Ser. No. 60/511,036 filed by Claus Knapheide on Oct. 14, 2003.

### FIELD OF THE INVENTION

The present invention generally relates to computer information systems. More particularly, the present invention relates to a medical information user interface and task management system.

### BACKGROUND OF THE INVENTION

Computer information systems for clinical applications (“a clinical system”) typically differentiate between browsing and content. After a user of a clinical system uses a browser to navigate through a hierarchical data tree structure (e.g., nested folders containing documents), the clinical system permits the user to select and work with a single type of data or tool. Permitted selections include pending or current elements for a patient, adding an element, browsing or any other type of catalog access tool for that same type of data, or to manage the current task with whatever functions are required. Users typically select a different task and lose sight and context of the previously operated data. Usually, users finalize and save their work until they can look up data in another category.

Clinical systems typically generate a data-driven model of data and tools. However, the representations of data with the clinical system are unlikely to match a user's mental model (e.g., workflow process) when: different data is observed, complex professional thinking is involved, and insight is derived from the exclusion of a possible data combination in a way that is unforeseen by the system.

More particularly, present clinical systems display medical data by category, then subcategory etc., each by time, but do not display combinations of data that reside in different areas of the data tree to provide insight into patient circumstances or clinical necessity that can lead to appropriate clinical decisions. This type of clinical system causes a user to either make notes, keep multiple instances of the clinical system open at the same time, or to rely on short-term memory to compare and relate information that have been categorized as distinct types of data or tools.

For example, looking up current instances of a data type and the initiation of a new type of data or activity for a patient logically have a lot in common, but they are not always related in a clinical workflow. Two adjacent steps of the workflow often touch on different tools and types of data, and the user often needs information from one step when utilizing another step. Accordingly, there is a need for a medical information user interface and task management system that overcomes these and other disadvantages of the prior systems.

### SUMMARY OF THE INVENTION

A healthcare delivery information management system, for managing provision of health care to a patient, includes an interface processor and a display processor. The interface processor receives information identifying a particular patient. The display processor initiates generation of data representing a composite display image including a first area, a second area, and a third area. The first area includes a first set of data items representing different types of healthcare information, and a second set of data items individually associated with corresponding items of the first set of data items. The display processor initiates generation of data representing a particular type of healthcare information for the particular patient in the second area in response to user selection of an individual item of the first set of data items. The display processor initiates generation of data representing current healthcare information of a particular type for the particular patient in the third area in response to user selection of an individual item of the second set of data items.

### BRIEF DESCRIPTION OF THE DRAWINGS

FIG. 1 illustrates a block diagram of a healthcare delivery information management system, in accordance with invention principles.

FIG. 2 illustrates a flowchart of a healthcare delivery information management method for the system, as shown in FIG. 1, in accordance with invention principles.

FIG. 3 illustrates a composite display image, including a first area displaying a general job bar and a second area displaying a first type of particular healthcare information for a patient, generated by a display processor in the system, as shown in FIG. 1, in accordance with invention principles.

FIG. 4 illustrates the composite display image, as shown in FIG. 3, including a third area displaying a second type of healthcare information for the patient, in accordance with invention principles.

FIG. 5 illustrates the composite display image, as shown in FIG. 3, including a fourth area displaying a third type of healthcare information for the patient, in accordance with invention principles.

FIG. 6 illustrates the composite display image, including a first area displaying a results job bar and a second area displaying second type of particular healthcare information, generated by a display processor in the system, as shown in FIG. 1, in accordance with invention principles.

FIG. 7 illustrates the composite display image, as shown in FIG. 6, including a fourth area displaying a third type of healthcare information for the patient, in accordance with invention principles.

### DETAILED DESCRIPTION OF THE PREFERRED EMBODIMENTS

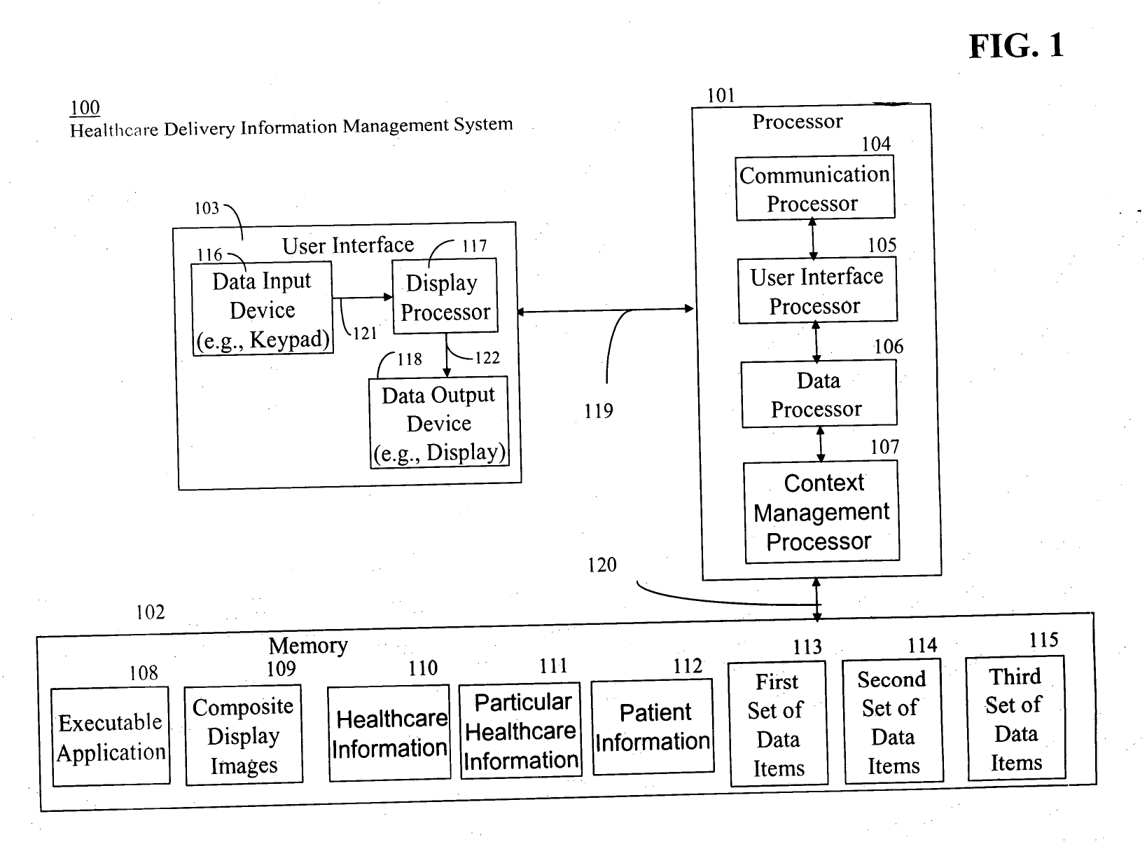

FIG. 1 illustrates a block diagram of a healthcare delivery information management system (“system”) 100. The system 100 includes a processor 101, a memory 102, and a user interface 103. The processor 101 further includes a communication processor 104, a user interface processor 105, a data processor 106, and a context management processor 107. The memory further includes an executable application 108, composite display images 109, healthcare information 110, particular healthcare information 111, patient information 112, and first 113, second 114, and third 115 sets of data items. The user interface 103 further includes a data input device 116, a display processor 117, and a data output device 118.

Any type of enterprise, organization, or department may employ the system 100, and is preferably intended for use by providers of healthcare products and/or services responsible for servicing the health and/or welfare of people in its care. In the preferred case, the system 100 represents a hospital information system. A healthcare provider may provide services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, a user, and an individual.

The system 102 may be fixed or mobile (i.e., portable), and may be implemented in a variety of forms including a server, a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch. The system 100 may be implemented in a centralized or decentralized configuration.

In the system 100, one or more elements may be implemented in hardware, software, or a combination of both. Further, one or more elements may include one or more processors, collectively represented as processor 101, such as the communication processor 104, the user interface processor 105, the data processor 106, and the context management processor 107. A processor includes any combination of hardware, firmware, and/or software. A processor acts upon stored and/or received information by computing, manipulating, analyzing, modifying, converting, or transmitting information for use by an executable procedure or an information device, and/or by routing the information to an output device. For example, a processor may use or include the capabilities of a controller or microprocessor.

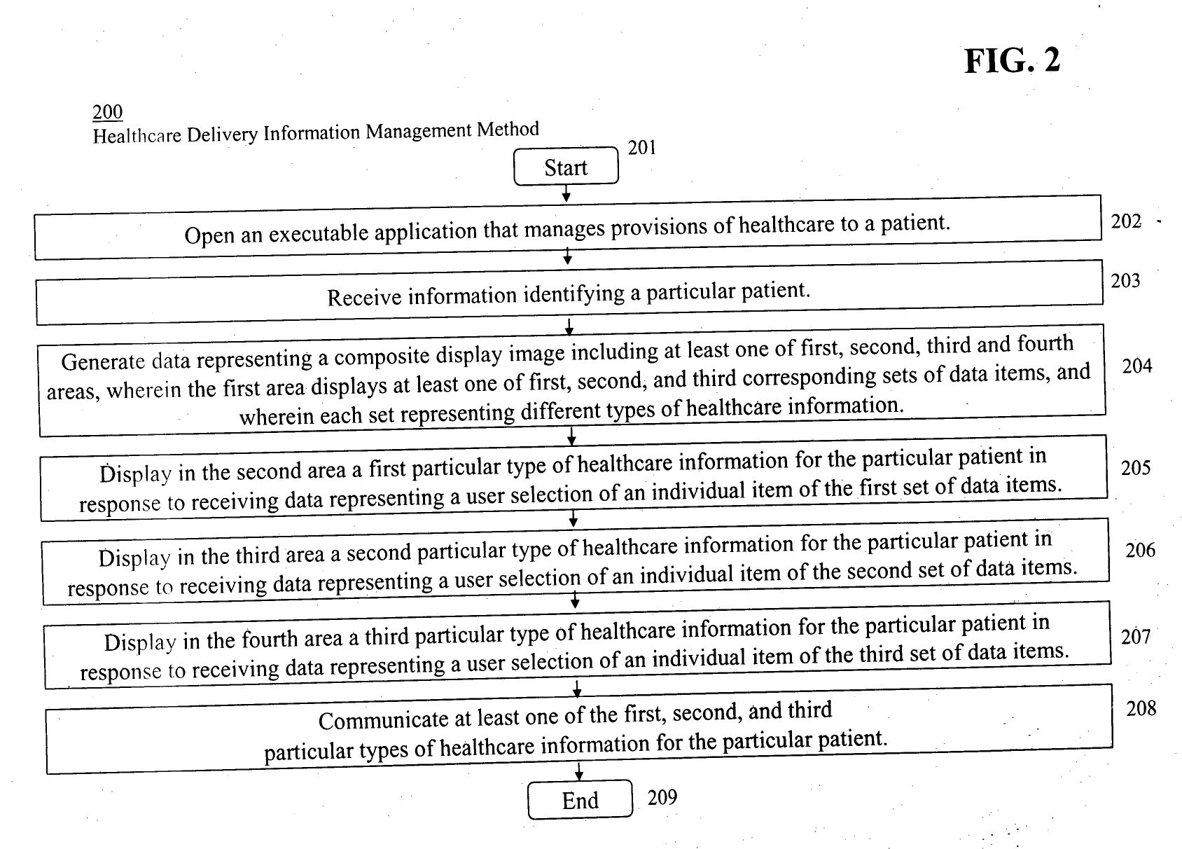

Generally, the processor 101 exchanges user interface data 119 with the user interface 103, and exchanges memory data 120 with the memory 102. The processor performs tasks in response to processing an object. An object comprises a grouping of data and/or executable instructions, an executable procedure, or an executable application 108, such as the method 200 in FIG. 2. An executable application comprises code or machine readable instruction for implementing predetermined functions including those of an operating system, healthcare information system, or other information processing system, for example, in response user command or input.

The communication processor 104 represents any type of communication interface that establishes communication links, by sending and/or receiving any type of signal, such as data, with multiple different devices via a communication path, otherwise called a network, a link, a channel, or a connection. The communication processor 104 establishes communications over a wired or wireless communication path using communication protocol data stored in the memory 102. The communication path may use any type of protocol or data format including an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol.

The user interface processor 105 manages communications of user interface data 119 between the processor 101 and the user interface 103. For example, the user interface processor 105 receives information causing the processor 101 to open an executable application that manages provisions of healthcare to a patient, and receives information causing the processor 101 to identify a particular patient.

The data processor 106 performs general data processing functions.

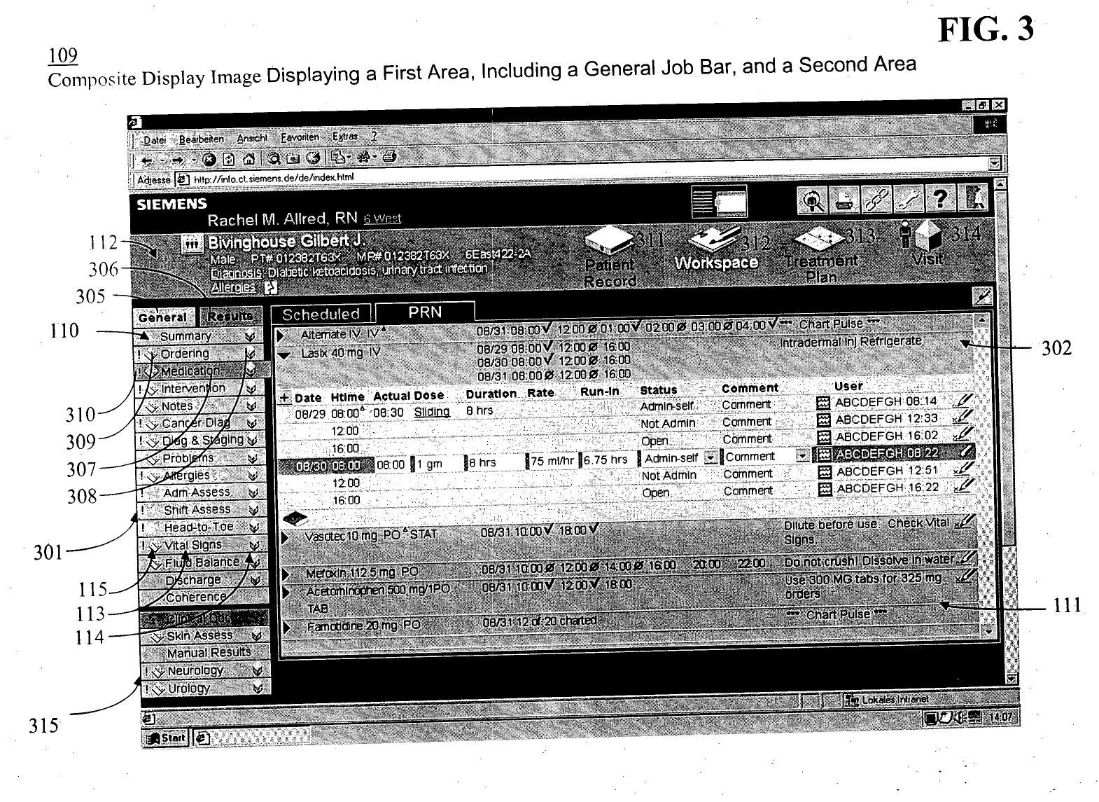

The context management processor 107 automatically passes context information between executable procedures supporting operation of functions displayed in one or more of the second 302, third 401 and fourth 501 (FIGS. 3-5) areas, without requiring repetitive user entry of the context information during user navigation between one or more of the second 302, third 401, and fourth 501 areas. The context information includes a patient identifier and one or more of the following: (a) a user identifier, (b) user authorization information, and (c) a computer operational session identifier. The executable procedures include one or more of the following: (a) a single executable application (such as application 108), and (b) different executable applications.

The memory 102 represents a data storage element and may otherwise be called a repository, a storage device, a database, a memory device, etc. The executable application 108 represents one or more software applications, programs, or functions, which control the operation of the system 100 according to predefined instructions. The method 200 in FIG. 2 is performed by an executable application 108 for the system 100.

The composite display images 109 (“images”) represent any images related to the system 100, such as, for example, the graphical user interface (GUI) images shown in FIGS. 3 to 7. The images 109 display output information and receive user input. The images 109 may have any type of format, layout, user interaction, etc., as desired, and are be limited to those shown in FIGS. 3 to 7. The GUI comprises a web browser, as shown in FIGS. 3 to 7, but may represent other display formats. The images 109 represent stored image templates that are modified by the processor 101 to support the method 200 in FIG. 2. Aspects of the present invention relate to the display of the composite display images 109, as shown in FIGS. 3 to 7.

The healthcare information 110 represents information associated with the general job bar 305 and a results job bar 306 in the first area 301, as shown in FIGS. 3 to 7.

The particular healthcare information 111 represents detailed healthcare information related to a particular patient that is associated with individual data items 307, 308, and 309 in the first 113, second 114, and third 115 sets of data items, respectively, as shown in FIGS. 3 to 7.

The patient information 112 represents detailed information related to one or more patients in the system 100, as shown in FIGS. 3 to 7.

The first 113, second 114, and third 115 sets of data items represent groups of user selectable individual data items 307, 308, and 309, respectively, linked to healthcare information for a particular patient. Each of the first 113, second 114, and third 115 sets of data items represents different types of healthcare information. The different types of healthcare information includes, for example, information associated with one or more of the following: (a) oncology, (b) allergies, (c) radiation, (d) staging, (e) prescription, (f) ordering, (g) radiology, (h) medication, (i) notes, (j) intervention, (k) a patient record, (l) admission, discharge or transfer, and (m) a patient flow sheet.

The user interface 103 provides a graphical user interface (GUI), as shown in FIGS. 3 to 7, for example, wherein portions of the data input device 116 and portions of the data output device 118 are integrated together via the display processor 117 to provide a user-friendly interface. The display processor 117 communicates user interface data 119, representing input data and/or output data, to the user interface processor 105.

The user interface data 119 may be represented in any file format including numeric files, text files, graphic files, video files, audio files, and visual files. The graphic files include a graphical trace including, for example, an electrocardiogram (ECG) trace, and an electroencephalogram (EEG) trace. The video files include a still video image or a video image sequence. The audio files include an audio sound or an audio segment. The visual files include an image including, for example, an ultrasound, nuclear image, a magnetic resonance image (MRI), an X-ray, a positive emission tomography (PET) scan, a computed tomography (CT) scan, an angiography, or a sonogram.

The user interface 103 permits a user to interact with the system 100 by inputting user interface data 121 into the system 100 and/or receiving user interface data 122 from the system 100. The user interface 103 generates one or more display images 109, as shown in FIGS. 3 to 7, for example.

The data input device 116 provides input data 121 to the display processor 117 in response to receiving input information either manually from a user or automatically from an electronic device. The data input device 116 is a keyboard and a mouse, but also may be a touch screen, or a microphone with a voice recognition application, for example.

The display processor 117 generates display data, representing one or more images 109 for display, in response to receiving the input data 121 or other data from the system 100, such as the user interface data 119. The display processor 117 is a known element including electronic circuitry or software or a combination of both for generating display images 109 or portions thereof. The image 109 for display may include any information stored in the memory 102 and any information described herein. An action by a user, such as, for example, an activation of a displayed button, may cause the image 109 to be displayed.

The data output device 118 represents any type of element that reproduces data for access by a user. The data output device 118 is a display that generates display images, as shown in FIGS. 3 to 7, in response to receiving the display signals, but also may be a speaker or a printer, for example.

FIG. 2 illustrates a flowchart of a healthcare delivery information management method 200 employed by the system 100, as shown in FIG. 1.

At step 201, the method 200 starts.

At step 202, the method 200 opens (i.e., starts or begins) the executable application 108 that manages provisions of healthcare to a patient. For example, a user causes the executable application to be opened using the user interface 103 in FIG. 2 in cooperation with the composite display images 109, as shown in FIGS. 3 to 7.

At step 203, the method 200 receives information identifying a particular patient. For example, a user enters the information (e.g., a patient's name, social security number, or patient identification number) into the system 100 using the user interface 103 in FIG. 2 in cooperation with the composite display images 109, as shown in FIGS. 3 to 7.

At step 204, the method 200 generates data representing a composite display image 109 including at least one of first 301, second 302, third 401, and fourth 501 areas, as shown in FIGS. 3 to 7. The first area 301 displays at least one of first 113, second 114, and third 115 corresponding sets of data items, as shown in FIGS. 3 to 7.

At step 205, the method 200 displays in the second area 302 a first particular type of healthcare information 111 for the particular patient in response to receiving data representing a user selection of an individual item 307 of the first set of data items 113, as shown in FIGS. 3 to 7. The system 100 displays the second area 302 adjacent to the right side of the first area 301.

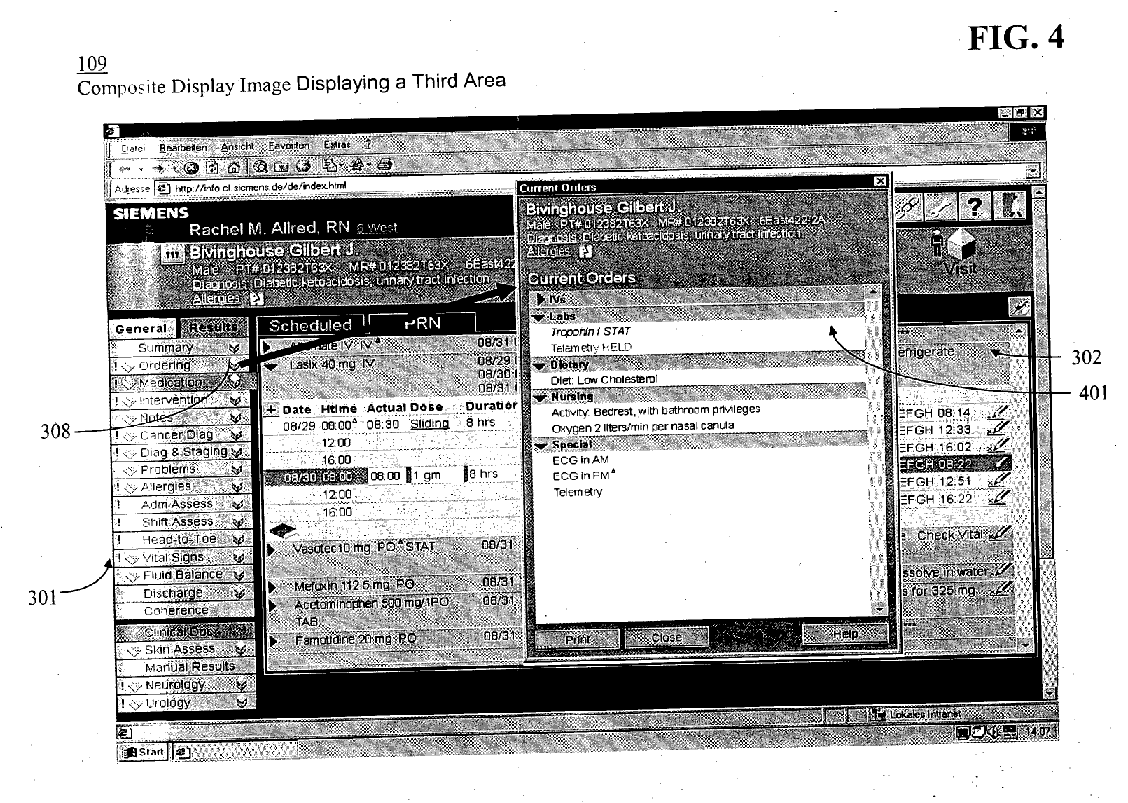

At step 206, the method 200 displays in the third area 401 a second particular type of healthcare information 111 for the particular patient in response to receiving data representing a user selection of an individual item 308 of the second set of data items 114, as shown in FIG. 4. The second particular type of healthcare information 111 is current healthcare information, for example. The current healthcare information includes one or more of the following: (a) currently valid healthcare information concerning the particular patient, (b) currently active medication orders for the particular patient, (c) currently active administration information for the particular patient, (d) currently active billing information concerning the particular patient, and (e) currently active clinician entered information concerning the particular patient. The current healthcare information includes exclusively current healthcare information of the second particular type of healthcare information 111 for the particular patient in the third area 401.

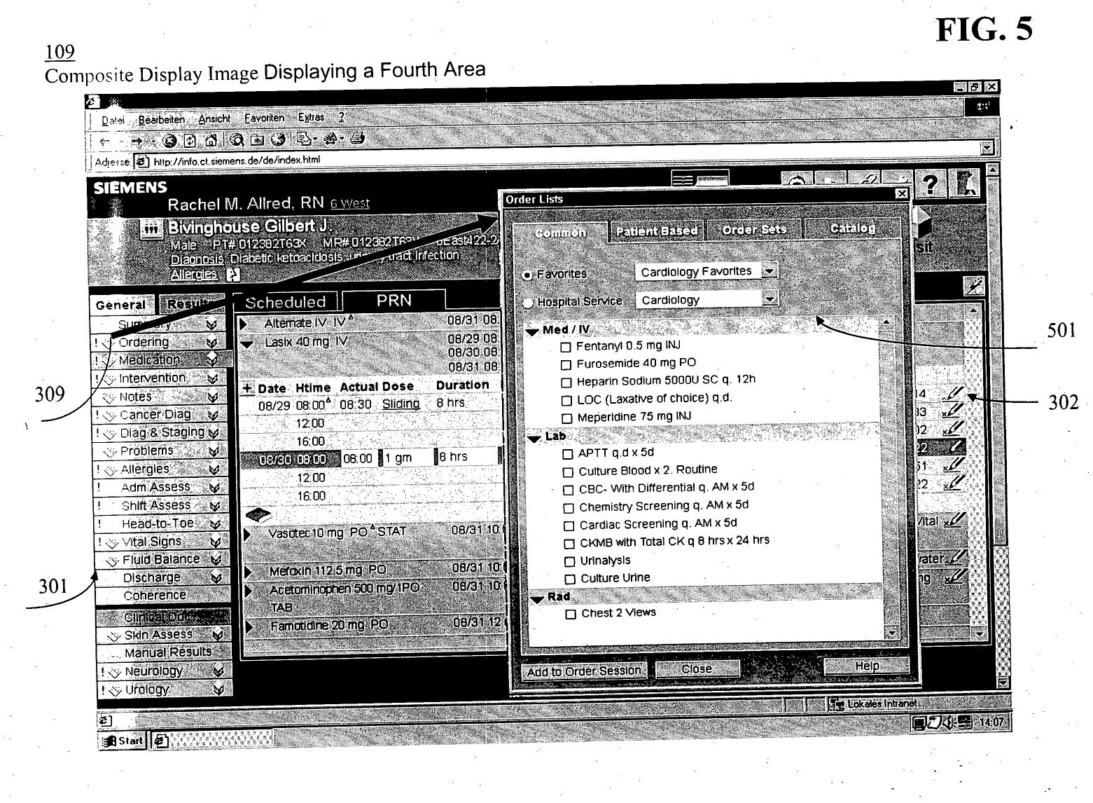

At step 207, the method 200 displays in the fourth area 501 a third particular type of healthcare information 111 for the particular patient in response to receiving data representing a user selection of an individual item 309 of the third set of data items 115, as shown in FIG. 5. The third set of data items 115 supports user activation of a function associated with the third particular type of healthcare information. The user activation of a function includes one or more of the following: (a) user ordering of an item, (b) user scheduling of a task for performance, (c) user initiation of a display of a form supporting information acquisition and entry, (d) user initiation of generation of a report, and (e) user initiation of a new function associated with the particular patient. The third particular type of healthcare information supporting user activation of a function associated with the particular type of healthcare information in a fourth area includes one or more of the following: (a) information enabling a user to initiate an order for a medication or service to be administered to the particular patient, (b) information enabling a user to initiate a task to be performed for the particular patient, (c) information enabling a user to initiate an administration function for the particular patient, (d) information enabling a user to initiate preparation of documentation concerning treatment of the particular patient, and (e) information enabling a user to enter information concerning the particular patient.

At step 208, the method 200 communicates at least one of the first, second, and third particular types of healthcare information 111 for the particular patient. The healthcare information 111 may be communicated to any destination in any manner such as, for example, electronic mail, voice mail, and printed material.

At step 209, the method 200 ends.

FIG. 3 illustrates a composite display image 109, including a first area 301 displaying a general job bar 305 and a second area 302 displaying a first type of particular healthcare information 111 for a patient, generated by a display processor 117 in the system 100, as shown in FIG. 1.

The patient information 112, located above the first 301 and second 302 areas, represents information related to one or more patients. The patient information 112 generally includes, for example, elements enabling user access to a patient's record 311, workspace 312, a patient's treatment plan 313, and a patient's visit 314, as shown in FIGS. 3 to 7. More particularly, the patient information 112 includes a patient's name, address, phone number, insurance coverage, sex, admission and discharge information, diagnosis, allergies, identification number, facility location, room number, doctor, etc., some of which are shown in FIGS. 3 to 7.

The patient's record element 311 initiates a function within the executable application 108 that contains data about a patient and provides a tool for the user to navigate to this information by time and content.

The patient's treatment plan element 313 initiates a function within the executable application 108 that filters clinical activities, including results by problem and/or diagnosis, and permits a time-based display of the clinical activities.

The patient's visit element 314 initiates a function within the executable application 108 related to billing and organizational aspects of the patient's visits. Some administrative data may be important for the user to access via the workspace 312.

The workspace element 312 initiates a function within the executable application 108 that permits a user to input and/or output salient healthcare information about a particular patient. Aspects of the present invention are related to the workspace 312, as shown in FIGS. 3 to 7. The workspace 312 advantageously provides a single user interface entry using the composite display image 109 for different types of healthcare information for a particular patient, thereby overcoming the limitations associated with the traditional upward or downward hierarchical user interface structure. FIGS. 3 to 7 illustrate that user selection of the workspace 312 function and enables the system 100 to display the first 301 and the second 302 areas in the composite display image 109.

The first area 301 includes general healthcare information 110 representing the general job bar 305 and a results job bar 306. Each of the job bars 305 and 306 include individual data items 307, 308, and 309 in the first 113, second 114, and third 115 sets of data items, respectively, and corresponding alerts 310, as shown in FIGS. 3 to 7.

User selection of the general job bar 305 displays the first set of data items 113 (i.e., “jobs”) as multiple boxes, each having text located therein, representing various different, individual user selections 307 related to general healthcare of the patient, as shown in FIGS. 3 to 5. The individual user selections 307 in first set of data items 113 include, for example, summary, ordering, medication, intervention, notes, cancer diagnosis, diagnosis and staging, problems, allergies, admission assessment, shift assessment, head-to-toe assessment, vital signs, fluid balance, discharge, and coherence, as shown in FIG. 3 to 5.

Depending on the number of jobs that the system 100 needs to support, there are one or more job bars. In the display image 109, there are two job bars 305 and 306. The user selects between the two job bars 305 and 306 using the tabs at the top of the job bars. If the system 100 requires additional job bars, the system 100 may display a drop down menu to permit user selection of multiple job bars.

The job bars 305 and 306 are grouped and separated by a header label (i.e., general and results). These headers are not collapsible and remain visible to the user, but they may be collapsible, if desired. The group headers for the lower, patient specific job bars 315 serves as access points to various types of clinical documentation that a user may need to access. It is desirable that the user can invoke a dialog from the job-bar, and the previously opened window would close automatically. The system 100 opens a message dialog prompting the user to save any unsaved data.

An individual data item in the first set of data items 113 (i.e., jobs or tasks) represents a user model that anticipates what information a user would want or need to enter or to know related to a particular patient. The system 100 advantageously supports workflow needs and task analysis of healthcare workers whilst optimizing efficiency and error prevention. For this purpose, an individual data item in the first set of data items 113 (i.e., each job) includes corresponding subsets represented as the second 114 and third 115 sets of data items.

The second set of data items 114 includes individual data items, such as data item 308. The system 100 represents the individual data items 308 as icons (e.g., a three dimensional box) displayed on the right side of the corresponding individual user selections 307 in first set of data items 113. The second set of data items 114 represents current or pending healthcare information for the particular patient, such current medication, valid consent forms, current vital signs, and pending orders, etc. The system 100 shows the icon when pending healthcare information is present in the link and does not show the icon when pending healthcare information is not present in the link.

The third set of data items 115 includes individual data items, such as data item 309. The system 100 represents the individual data items 309 as icons (e.g., a two dimensional square) displayed on the left side of the corresponding individual user selections 307 in first set of data items 113. The third set of data items 115 represents new or desired healthcare information for the particular patient, such as ordering for new medication, starting a new consent form, charting new vital signs, and placing new orders, etc. The system 100 shows the icon for jobs 113 that may need to add new healthcare information.

The system 100 represents the alerts 310 as icons (e.g., an exclamation point) displayed on the left side of the corresponding individual user selections 307 in first set of data items 113 and on the left side corresponding third data items 309. The alerts 310 represent jobs 113 that need attention for various reasons (e.g., pending jobs, overdue, signature missing, conflict). The alerts 310 are indicators and do not provide links to other areas, but may provide a link to or a message related to the area of the conflict.

A time selector (not shown) may also be incorporated into the display image 109 to permit a user to change the time reference for the content of the workspace 312. The time selector sets the scope for the data displayed in the second area 302. Possible selections of time include, for example, are current, now, shift, one, three, seven, and thirty-one days. The time selector needs to allow user to select times greater than thirty-one days, because a user may need to see results six months to a year ago. If a task area requires a certain time selection and the user switches to this task with a non-consistent time selected, the selector switches to a default time, indicating this on the selector in color-coding, for example, or other indication.

The combination of the first 113, second 114, and third 115 sets of data items and the corresponding alerts 310 advantageously permit the user to instantly access and use the healthcare information to either document findings or to communicate required activities related to a particular patient. The system 100 displays healthcare information related to at least one of the first 113, second 114, and third 115 sets of data items either in the second area 302 or in the foreground (e.g., the third area 401 in FIG. 4 or the fourth area 501 in FIG. 5) of the second area 302. The second area 302 may otherwise be referred to as the “well” of the composite display image 109.

A user advantageously manages the workspace 312 by having access to healthcare information related to one or more of the first 113, second 114, and third 115 sets of data items at the same or different times, thereby permitting efficient management of a patient's healthcare information. The system 100 advantageously permits users to recombine healthcare information in order to support efficient clinical decision making, thereby overcoming the limited display space associated with computer displays.

The system 100 advantageously enables job-focused periods of data consultation (e.g., data viewing, editing, and entry) and add-to-scope periods. A job represents one package of analysis, such as orders, consent forms, medication etc. However, single types of jobs 315, such as clinical documentation, which is a collection category in itself, constitute single jobs, as shown below the job bars 305 and 306. Clinical jobs are complex and it is critical to maintain the job structure for efficiency and error prevention. A single user touches on an abundance of jobs during a day, and most jobs involve multiple users. There is a certain routine that users follow as they organize their patient-centric jobs. While some activities are considered standard or primary, others happen less frequently and can be referred to as secondary.

In the composite display image 109, the user may look up or enter information that belongs to a different data type, without completely leaving the main task or job. For example, while the user checks medication administration, the user wants to check the last vital signs, the list of lab orders, or determine whether the consent form for that chemotherapy drug is about to expire. In another example, while the user reads a certain report, the user wants to place a new order or write a progress note. The workspace 312 beneficially permits a user to manage a an item in the first set of data items 113 in the background, to review an item in the second set of data items 114 and to start an item in the third set of data items 115 in the same composite display image 109. Presently, these three sets of data items 113, 114, and 115 belong to different categories and a system would need to access and display the healthcare information in different display images.

The composite display image 109 advantageously maintains communality between the workspaces 312 for various user roles supported by the executable application 108. Although the relevance or urgency of a task varies slightly between healthcare workers, the system 100 displays the display image 109 in the same way, so that healthcare workers can help each other and so that the display image 109 appears consistent for multiple users.

The second area 302 displays particular healthcare information 111 for a patient. The system 100 displays a first particular type of healthcare information 111 for the particular patient in the second area 302 in response to receiving data representing a user selection of an individual item 307 of the first set of data items 113, as shown in FIGS. 3 to 7. For example, in FIGS. 3 to 5, user selection of individual item 307, such as “Medication,” causes the system 100 to generate medication information for the particular patient in the second area 302.

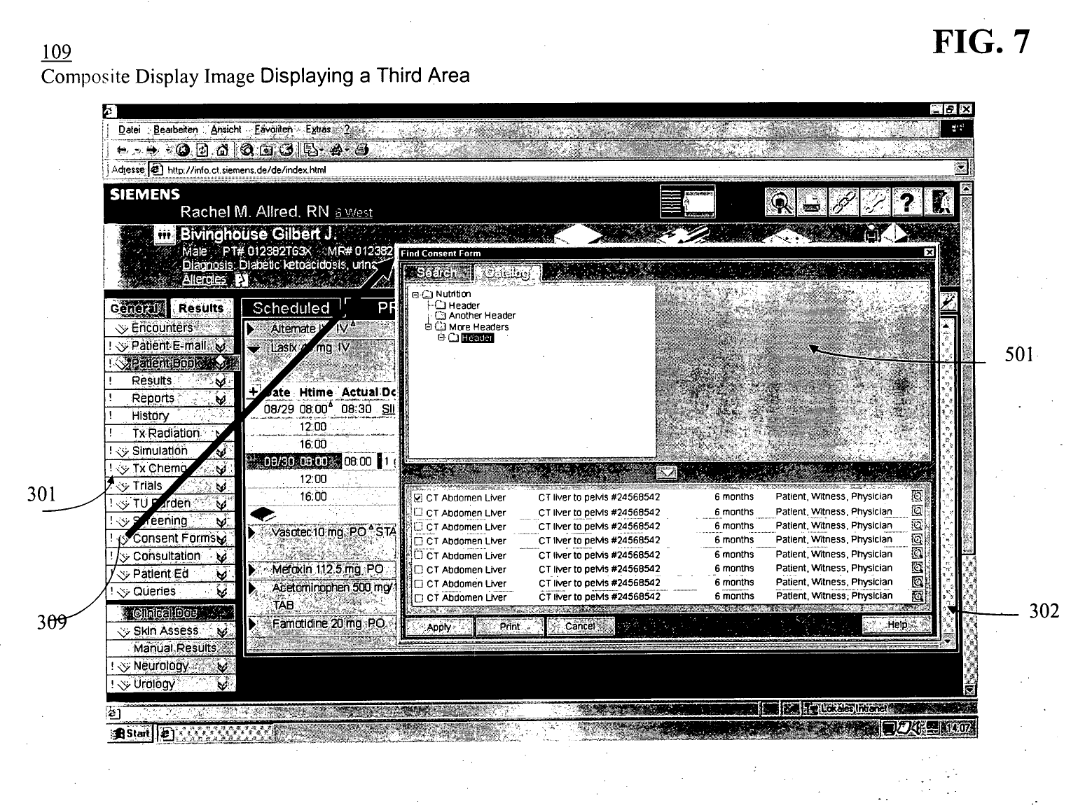

The first 113, the second 114, and the third 115 sets of data items represent different types of healthcare information. The system 100 displays first, second, and third particular type of healthcare information 111 for the particular patient in the second 302 (FIGS. 3 to 7), third 401 (FIG. 4), and fourth 501 (FIGS. 5 and 7) areas, respectively, in response to receiving data representing a user selection of an individual item 307, 308, and 309, respectively, in the first 113, second 114, and third 115 sets of data items, respectively. For example, the system 100 displays a first particular type of healthcare information 111 related to medication for the particular patient in the second area 302 in response to receiving data representing a user selection of an individual data item 307, such as “medication” in the first set of data items 113, as shown in FIGS. 3 to 5. Likewise, the system 100 displays various particular types of healthcare information 111 for the particular patient in the second area 302 in response to receiving data representing a user selection of various other individual data items 307 in the first set of data items 113.

FIG. 4 illustrates the composite display image 109, as shown in FIG. 3, including a third area 401 displaying a second type of healthcare information 111 for the patient. FIG. 4 is the same as FIG. 3 except for a new window that displays the second type of healthcare information 111 for the patient in the third area 401.

The system 100 displays the second particular type of healthcare information 111 for the particular patient in the third area 401 in response to receiving data representing a user selection of an individual data item 308 in the second set of data items 114. For example, the system 100 displays the second particular type of healthcare information 111, related to “current orders” for the particular patient in the third area 401 in response to receiving data representing a user selection of an individual data item 308, located on the right side of the data item “ordering” in the first set of data items 113. Current orders for the particular patient in the third area 401 include, for example, intravenous (IVs), labs, dietary, nursing, and special orders. The new window, having the third area 401, includes a scroll bar, and print, close, and help selection boxes.

The system 100 displays the third area 401 in the foreground overlaying the second area 302 thereby obstructing a portion of the second area 302, while permitting the first area 301 to remain unobstructed and visible to the user.

Likewise, the system 100 displays various particular types of healthcare information 111 for the particular patient in the third area 401 in response to receiving data representing a user selection of various other individual data items 308 in the second set of data items 114. A user selects the individual data item 308 in the second set of data items 114, for example, by double clicking on the icon.

The arrow from the icon, representing the individual data item 308, to the new window having the third area 401 graphically represents the direct relationship between the icon and the new window, and may or may not be used. Likewise, the text “current orders” at the top of the new window having the third area 401 alphabetically represents the direct relationship between the text next to the icon (i.e., orders) and the new window, and may or may not be used.

FIG. 5 illustrates the composite display image 109, as shown in FIG. 3, including a fourth area 501 displaying a third type of healthcare information 111 for the patient. FIG. 5 is the same as FIG. 3 except for a new window that displays the third type of healthcare information 111 for the patient in the fourth area 501.

The system 100 displays the third particular type of healthcare information 111 for the particular patient in the fourth area 501 in response to receiving data representing a user selection of an individual data item 309 in the third set of data items 115. For example, the system 100 displays the third particular type of healthcare information 111, related to “order lists” for the particular patient in the fourth area 501 in response to receiving data representing a user selection of an individual data item 309. Order lists for the particular patient in the fourth area 501 include categories described as, for example, common, patient based, order sets, and catalog. The common order lists include, for example, medications/intra-venous (IVs), lab, and radiation orders. The new window, having the fourth area 501, includes a scroll bar, as well as “add to order,” close, and help selection boxes.

The system 100 displays the fourth area 501 in the foreground overlaying the second area 302 thereby obstructing a portion of the second area 302, while permitting the first area 301 to remain unobstructed and visible to the user. When desired, the system 100 displays the third area 401 adjacent to the left side of the fourth area 501 in the foreground overlaying the second area 302 thereby obstructing a portion of the second area 302, while permitting the first area 301 to remain unobstructed and visible to the user.

Likewise, the system 100 displays various particular types of healthcare information 111 for the particular patient in the fourth area 501 in response to receiving data representing a user selection of various other individual data items 309 in the third set of data items 115. A user selects the individual data item 309 in the third set of data items 115, for example, by double clicking on the icon.

The arrow from the icon, representing the individual data item 309, to the new window having the fourth area 501 graphically represents the direct relationship between the icon and the new window, and may or may not be used. Likewise, the text “order lists” at the top of the new window having the fourth area 501 alphabetically represents the direct relationship between the text next to the icon (i.e., orders) and the new window, and may or may not be used.

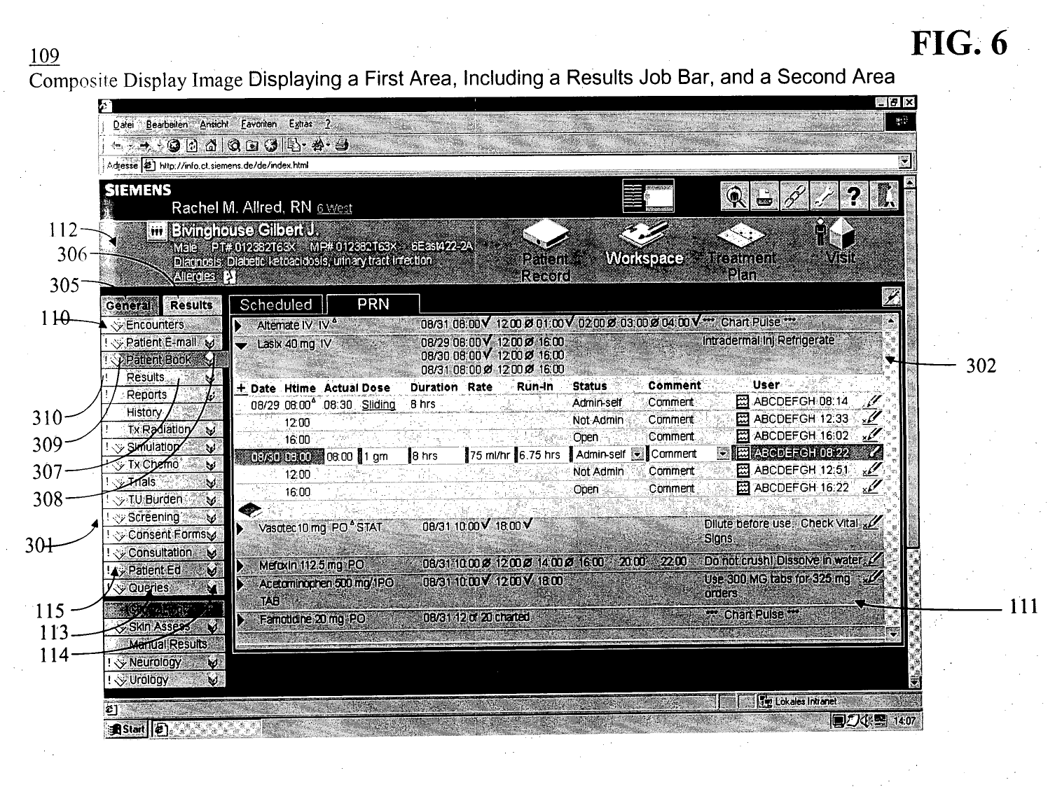

FIG. 6 illustrates the composite display image 109, including the first area 301 displaying the results job bar 306 and the second area 302 displaying the first type of particular healthcare information 111, generated by a display processor 117 in the system 1100, as shown in FIG. 1. FIG. 6 is the same as FIG. 3 except that the system 100 displays the results job bar 306 rather than the general job bar 305 in the first area 301.

User selection of the results job bar 306 displays the first set of data items 113 as multiple boxes, each having text located therein, representing various different, individual user selections related to results of healthcare of the patient, as shown in FIGS. 6 and 7. The first set of data items 113 under the results job bar 306 include, for example, encounters, patient E-mail, patient book, results, report, history, Tx radiation, simulation, Tx chemo-therapy, trials, TU burden, screening, consent forms, consultation, patient education, and queries, as shown in FIGS. 6 and 7.

The system 100 displays first, second, and third particular type of healthcare information 111 for the particular patient in the second 302 (FIGS. 6 and 7), third 401 (not shown), and fourth 501 (FIG. 7) areas, respectively, in response to receiving data representing a user selection of an individual item 307, 308, and 309, respectively, in the first 113, second 114, and third 115 sets of data items, respectively. The system 100 displays various particular types of healthcare information 111 for the particular patient in the second area 302 in response to receiving data representing a user selection of various other individual data items 307 in the first set of data items 113.

FIG. 7 illustrates the composite display image 109, as shown in FIG. 6, including a fourth area 501 displaying a third type of healthcare information 111 for the patient. FIG. 7 is the same as FIG. 6 except for a new window that displays the third type of healthcare information 111 for the patient in the fourth area 501.

The system 100 displays the third particular type of healthcare information 111 for the particular patient in the fourth area 501 in response to receiving data representing a user selection of an individual data item 309 in the third set of data items 115. For example, the system 100 displays the third particular type of healthcare information 111, related to “find consent form” for the particular patient in the fourth area 501 in response to receiving data representing a user selection of an individual data item 309. Consent forms for the particular patient in the fourth area 501 may be found, for example, by searching or by catalog. The catalog include, for example, one or more nested folders, which include appropriate corresponding consent forms. The new window, having the fourth area 501, includes apply, print, cancel, and help selection boxes.

Likewise, the system 100 displays various particular types of healthcare information 111 for the particular patient in the fourth area 501 in response to receiving data representing a user selection of various other individual data items 309 in the third set of data items 115. A user selects the individual data item 309 in the third set of data items 115, for example, by double clicking on the icon.

The arrow from the icon, representing the individual data item 309, to the new window having the fourth area 501 graphically represents the direct relationship between the icon and the new window, and may or may not be used. Likewise, the text “find consent forms” at the top of the new window having the fourth area 501 alphabetically represents the direct relationship between the text next to the icon (i.e., consent forms) and the new window, and may or may not be used.

Advantages

The system 100 advantageously provides a user direct access to the four areas 301, 302, 401, and 501. The direct access permits the user to make a direct decision to look-up patient information (e.g. in response to an alert or by choice via the list of current/pending entities), to start a new instance for a select category, or to use the full support that is provided by the composite display images 109. The user can also look up data of another category or initiate additional activity. The system 100 advantageously addresses the problems of direct composition of different types of information, inclusion of additional information that is composed of different data types, and generation of an alert concerning any type of patient-centric problems whilst working on another type of data or activity for that patient.

The system 100 advantageously performs the following:
1. Separates four aspects of one type of activity or data and makes them separately accessible for the user.
2. Provides a user interface based on a model of use rather than a static data structure driven model.
3. Differentiates between data (i.e., system) driven activities and user (plus patient) driven activities and letting the user decide in which order to address these.
4. Allows the combination of two different types of data and data make-ups to be displayed concurrently in order to better support workflow (e.g., data comparison and transfer, sliding transition from one data type/activity to another).
5. Provides any combination of data in three areas on one display screen, without a need to specifically design user interface solutions for each particular combination.
6. Displays data for categories of data or activity.
7. Reduces the need for users to short-term memorize clinical detail or status information.
8. Permits on-screen comparison of patient-related data.
9. Maximizes ease of use by directly displaying a subset of possible patient data.
10. Avoids attention deficit mistakes using patient-centric alerts 310.

### EXAMPLES

The following examples describe how a user uses the composite display images 109 in the system 100. In a first example, the second 302, third 401, and fifth 501 areas each include healthcare information that share common content. When the second area 302 displays a consent form and the user selects the icon 308, representing current consent forms, the system 100 permits the user to select another consent form causing the system 100 to update the healthcare information in the second area 302. The second area 302 displays the new consent form when the user selects a new consent form from the consent form catalog/browser.

In a second example, the second 302, third 401, and fifth 501 areas each include healthcare information that share mixed content. When the system 100 displays information about an item in the first set of data items 113 (e.g., reports) in the second area 302 and the user opens an item in the second set of data items 114 (e.g. current consent forms), the system 100 displays the item in the second set of data items 114 (e.g., current consent forms) in the third area 401, but the user cannot invoke an item in the third set of data items 115 (e.g. a new consent form) from the second set of data items 114. When the user selects an item in the third set of data items 115 (e.g., a new consent form), the system 100 appends the item in the third set of data items 115 (e.g. a new consent form) to the second set of data items 114 (e.g., current consent forms) displayed in the third area 401, but the user would need to switch from a first item in the first set of data items 113 (e.g., reports) to a second item in the second set of data items 113 (e.g., consent forms) to display the corresponding information for the item (e.g., consent form) in the second set of data items in the second area 302.

In a third example, physicians may use the system 100 as follows.
1. During ordering workflows, as a physician places patient orders, the physician may look up clinical data, current meds, consent, and scheduling status, etc.
2. As the physician looks at results, reports, current medications, etc., the physician may place new orders and select therapeutic and diagnostic steps for the patient.
3. As the physician assesses the diagnosis and stage for a patient, the physician may order tests or look up results to assess the patient status.

In a fourth example, nurses may use the system 100 as follows.
1. To check charts, a nurse compares the orders for medications and the medications that are actually being administered.
2. While the nurse performs activities for a patient, the nurse looks up the result status or the exact order.

In a fifth example, healthcare providers may use the system 100 as follows.
1. Healthcare providers are alerted to items that need attention as they are-working on/with data for a patient.

Alternative

As an alternative to the flexibility offered by the three areas 302 (FIGS. 3 to 7), 401 (FIG. 4), and 501 (FIGS. 5 and 7), multiple specific combinations of preferred data displays could be made available via user selectable shortcuts. For example, in order to support twenty-four hour chart check, the system 100 provides access to the list of current medications after the user prompted the system 100 to display the list of current orders.

The system 100 and method 200 provide a composite display image 109 permitting concurrent selection and use of multiple, different functions, displayed in multiple areas of the image 109, associated with healthcare for a particular patient. Such functions include, for example, data display, data entry, and service selection for current and/or pending data items and corresponding alerts.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

1. A healthcare delivery information management system for managing provision of health care to a patient, comprising:
an interface processor for receiving information identifying a particular patient; and
a display processor for initiating generation of data representing a composite display image including,
a first area presenting a first set of data items representing different types of healthcare information and a particular type of healthcare information is displayed for said particular patient in a second area of said composite image in response to user selection of an individual item of said first set, and
said first area includes a second set of data items, individually associated with corresponding items of said first set and current healthcare information of a particular type is displayed for said particular patient in a third area of said composite image in response to user selection of an individual item of said second set.

2. A system according to claim 1, wherein
said first area including a third set of data items, individually associated with corresponding items of said first set and information supporting user activation of a function associated with a particular type of healthcare information is displayed for said particular patient in a fourth area of said composite image in response to user selection of an individual item of said third set.

3. A system according to claim 2, wherein
said user activation of a function comprises at least one of, (a) user ordering of an item, (b) user scheduling of a task for performance, (c) user initiation of a display of a form supporting information acquisition and entry, (d) user initiation of generation of a report and (e) user initiation of a new function associated with said particular patient.

4. A system according to claim 2, wherein
said system automatically passes context information between executable procedures 108 supporting,
(a) displaying said particular type of healthcare information concerning said particular patient in said second area,
(b) displaying said exclusively current healthcare information of said particular type in said third area, and
(c) displaying information supporting user activation of said function associated with said particular type of healthcare information in said fourth area,
without requiring repetitive user entry of said context information during user navigation between said second, third, and fourth areas.

5. A system according to claim 4, wherein
said context information comprises a patient identifier and at least one of, (i) a user identifier, (ii) user authorization information and (iii) a computer operational session identifier.

6. A system according to claim 4, wherein
said executable procedures comprise at least one of, (i) a single executable application and (ii) different executable applications.

7. A system according to claim 1, wherein
said first area remains visible in said composite image and
and at least one of, (a) said third area and (b) said fourth area, is presented in the image foreground overlaying said second area of said composite image.

8. A system according to claim 1, wherein
said different types of healthcare information includes information associated with at least one of, (a) oncology, (b) allergies, (c) radiation, (d) staging, (e) prescription, (f) ordering, (g) radiology, (h) medication, (i) notes, (j) intervention, (k) a patient record, (l) admission, discharge or transfer and (m) a patient flow sheet.

9. A system according to claim 1, wherein
said current healthcare information of said particular type in said third area comprises at least one of, (a) currently valid healthcare information concerning said particular patient, (b) currently active medication orders for said particular patient, (c) currently active administration information for said particular patient, (d) currently active billing information concerning said particular patient, (e) currently active clinician entered information concerning said particular patient.

10. A system according to claim 9, wherein
said current healthcare information comprises exclusively current healthcare information of said particular type in said third area.

11. A system according to claim 2, wherein
said information supporting user activation of a function associated with said particular type of healthcare information in a fourth area comprises at least one of, (a) information enabling a user to initiate an order for a medication or service to be administered to said particular patient, (b) information enabling a user to initiate a task to be performed for said particular patient, (c) information enabling a user to initiate an administration function for said particular patient, (d) information enabling a user to initiate preparation of documentation concerning treatment of said particular patient and (e) information enabling a user to enter information concerning said particular patient.

12. A healthcare delivery information management system for managing provision of health care to a patient, comprising:
an interface processor for receiving information identifying a particular patient; and
a display processor for initiating generation of data representing a composite display image including,
a first area presenting a first, second and third set of data items enabling a user to correspondingly initiate,
(a) displaying a particular type of healthcare information concerning said particular patient in a second area,
(b) displaying current healthcare information of said particular type in a third area, and
(c) displaying information supporting user activation of a function associated with said particular type of healthcare information in a fourth area.

13. A system according to claim 12, including
a context management processor for automatically passing context information between executable procedures supporting operation of functions displayed in said second, third and fourth areas without requiring repetitive user entry of said context information during user navigation between said second, third and fourth areas.

14. A system according to claim 12, wherein
said current healthcare information of said particular type in said third area comprises at least one of, (a) currently valid healthcare information concerning said particular patient, (b) currently active medication orders for said particular patient, (c) currently active administration information for said particular patient, (d) currently active billing information concerning said particular patient, (e) currently active clinician entered information concerning said particular patient.

15. A system according to claim 14, wherein
said current healthcare information comprises exclusively current healthcare information of said particular type in said third area.

16. A system according to claim 12, wherein
said information supporting user activation of a function associated with said articular type of healthcare information in a fourth area comprises at least one of, (a) information enabling a user to initiate an order for a medication or service to be administered to said particular patient, (b) information enabling a user to initiate a task to be performed for said particular patient, (c) information enabling a user to initiate an administration function for said particular patient, (d) information enabling a user to initiate preparation of documentation concerning treatment of said particular patient and (e) information enabling a user to enter information concerning said particular patient.

17. A method comprising the steps of:
opening an executable application that manages provisions of healthcare to a particular patient;
receiving information identifying the particular patient;
generating data representing a composite display image including at least one of first, second, third and fourth areas, wherein the first area displays at least one of first, second, and third corresponding sets of data items, and wherein each set representing different types of healthcare information;
displaying in the second area a first particular type of healthcare information for the particular patient in response to receiving data representing a user selection of an individual item of the first set of data items;
displaying in the third area a second particular type of healthcare information for the particular patient in response to receiving data representing a user selection of an individual item of the second set of data items; and
displaying in the fourth area a third particular type of healthcare information for the particular patient in response to receiving data representing a user selection of an individual item of the third set of data items.

18. A method according to claim 17, further comprising the step of:
communicating at least one of the first, second, and third particular types of healthcare information for the particular patient.

19. A method according to claim 17, wherein second particular type of healthcare information further comprises:
current healthcare information.

20. A method according to claim 17, wherein third particular type of healthcare information further comprises:
new healthcare information.
